(19) United States
(12) Patent Application Publication
(10) Pub. No.: US 2026/0125558 A1
(43) Pub. Date: May 7, 2026

(54) THERMOSETTING FOAM TYPE BINDER COMPOSITION, MAGNETIC PAD COMPRISING THE SAME, AND WIRELESS CHARGING DEVICE COMPRISING THE SAME

(71) Applicants: Hyundai Motor Company, Seoul (KR); Kia Corporation, Seoul (KR); KCC Corporation, Seoul (KR)

(72) Inventors: Young Min Kim, Hwaseong-si (KR); Jungin Lee, Asan-si (KR); Seungmin Hong, Hwaseong-si (KR); Gwang-Gyu Kim, Seoul (KR); Kyounghoon Kang, Suwon-si (KR); Myoungsoo Chun, Uijeongbu-si (KR); Taewook Lim, Yongin-si (KR); Yusuk Jung, Seoul (KR)

(21) Appl. No.: 19/025,235

(22) Filed: Jan. 16, 2025

(30) Foreign Application Priority Data
Nov. 1, 2024 (KR) 10-2024-0153507

(51) Int. Cl. C08L 83/06; C08G 77/20; C08J 9/00; C08J 9/18; H01F 7/02

(52) U.S. Cl. CPC C08L 83/06; C08G 77/20; C08J 9/0066; C08J 9/18; C08L 2203/14; C08L 2203/20; C08L 2205/025; H01F 7/02

(57) ABSTRACT

A thermosetting foam type binder composition can include a main polymer resin and a foaming agent having a foaming initiation temperature of 70 to 110° C., a foaming rate of 50 to 400%, and a viscosity of 3,000 to 100,000 cP. A magnetic pad can incorporate such thermosetting foam type binder composition. A wireless charging device can incorporate such magnetic pad.

### CROSS-REFERENCE TO RELATED APPLICATIONS

This present application claims the benefit of priority to Korean Patent Application No. 10-2024-0153507, filed on Nov. 1, 2024, in the Korean Intellectual Property Office, the entire disclosure of which is incorporated herein by reference.

### TECHNICAL FIELD

The present disclosure relates to a thermosetting foam type binder composition, a magnetic pad comprising the same, and a wireless charging device comprising the same.

### BACKGROUND

Recently, due to the supply expansion of electric vehicles, there is increasing interest in wireless charging technology capable of free charging of batteries without a wired charger. The wireless charging technology basically consists of a transmitter that transmits power and a receiver that receives the transmitted power, and these transmitter and receiver are composed of coils and magnetic materials. The magnetic material used herein is one of key components that determine the efficiency of wireless charging, and is provided in a wireless charging device in the form of a pad. Ferrite tiles were mainly applied to these magnetic pads, but ferrite tile magnetic materials are strongly brittle due to the nature of ceramic tiles to be vulnerable to impacts, and have a disadvantage of making it difficult to be manufactured in a three-dimensional shape. In particular, in the case of a receiver (vehicle) of a wireless charging system for electric vehicles, there is a disadvantage that the ferrite tile magnetic material may be easily damaged by vibration and external impact while driving. To overcome this disadvantage, efforts have been made to manufacture ferrite magnetic materials that are resistant to external impact. In particular, research has been conducted on flexible materials capable of replacing strongly brittle ferrite tiles, and research has also been actively conducted on binders optimized for these materials.

### SUMMARY

The present disclosure relates to a thermosetting foam type binder composition, a magnetic pad including the same, and a wireless charging device including the same, and more particularly, to a thermosetting foam type binder composition having thermosetting and foaming characteristics, including a main polymer resin and a foaming agent, a magnetic pad including the same, and a wireless charging device including the same.

An embodiment of the present disclosure can solve the above-described problems in the related art, and an embodiment of the present disclosure can provide a thermosetting foam type binder composition that includes a polymer resin and a foaming agent to expand in volume and be cured simultaneously when exposed to heat, thereby exhibiting excellent impact resistance and mechanical properties, a magnetic pad including the same, and a wireless charging device including the same.

An embodiment of the present disclosure can provide a thermosetting foam type binder composition including a main polymer resin and a foaming agent, and having a foaming initiation temperature of 70 to 110° C., a foaming ratio of 50 to 400%, and a viscosity of 3,000 to 100,000 cP.

An embodiment of the present disclosure can provide a magnetic pad including 65 to 95 parts by weight of magnetic material pellets, 10 to 25 parts by weight of magnetic material powder, and 1.5 to 7 parts by weight of a thermosetting foam type composition according to various embodiments of the present disclosure.

An embodiment of the present disclosure can provide a wireless charging device including a magnetic pad according to an embodiment of the present disclosure.

According to an embodiment of the present disclosure, in a magnetic pad including a binder composition, volume expansion and curing reaction can occur when molded by pressing or heating. Accordingly, using an embodiment of the present disclosure, it can be possible to secure excellent appearance, mechanical strength, and impact resistance.

A magnetic pad according to an embodiment of the present disclosure can have excellent electromagnetic properties and may be resistant to external impact.

A binder composition according to an embodiment of the present disclosure can have excellent moldability to improve workability when mixed with ferrite pellets or powder. Therefore, in accordance with an embodiment of the present disclosure, a magnetic pad including such binder composition can also have high design freedom.

### BRIEF DESCRIPTION OF THE DRAWINGS

The above and other features and advantages of example embodiments of the present disclosure can become apparent from the detailed description of the example embodiments in conjunction with the accompanying drawings, in which:

FIG. 1 shows images of the appearances observed with the naked eye in Example 5-2 and Comparative Example 3-2 of example embodiments of the present disclosure;

FIG. 2 shows images of the appearances observed with the naked eye in Example 1-2 and Comparative Example 4-2 of example embodiments of the present disclosure; and

FIG. 3 shows a graph comparing density and permeability of Examples and Comparative Examples of example embodiments of the present disclosure.

### DETAILED DESCRIPTION OF ILLUSTRATIVE EMBODIMENTS

Terms used herein including technical or scientific terms can have same meanings as generally understood by those skilled in the art unless otherwise defined. Terms defined in a generally used dictionary can be construed to have meanings matching those in the context of a related art.

As used herein, terms including as “first,” “second,” and the like, may be used for describing various components, but the components are not necessarily limited by these terms. These terms can be used merely to distinguish one component from another component. For example, without departing from the scopes of the present disclosure, a first component may be named as a second component, and similarly, a second component may be named as a first component.

Terms used herein can be used only to describe specific examples, and are not intended to necessarily limit the present disclosure. A singular expression can include a plural expression unless otherwise defined differently in a context. In the present disclosure, it can be understood that the term “including” or “having” or “comprising” indicates that a feature, a number, a step, an operation, a component, a part, or a combination thereof described in the specification is present, but does not exclude a possibility of presence or addition of one or more other features, numbers, steps, operations, components, parts, or combinations thereof, in advance.

A thermosetting foam type binder composition of an embodiment of the present disclosure may include a main polymer resin and a foaming agent.

In an embodiment of the present disclosure, the main polymer resin may include at least one selected from the group consisting of a silicone resin, a urethane resin, an epoxy resin, a polyester resin, and an acrylic resin.

In various embodiments of the present disclosure, the main polymer resin may be a two-component type polymer resin. In one example, the main polymer resin may be a two-component type polymer resin including a first component including vinyldimethylpolysiloxane and a second component including organohydrogenpolysiloxane.

The first component may further include dimethylpolysiloxane.

The first component may include 25 to 35 parts by weight of vinyldimethylpolysiloxane and 1 to 10 parts by weight of dimethylpolysiloxane.

The second component may further include vinyldimethylpolysiloxane.

The second component may include 20 to 30 parts by weight of vinyldimethylpolysiloxane and 5 to 15 parts by weight of organohydrogenpolysiloxane.

In an embodiment of the present disclosure, the first component and the second component may be mixed or stirred and molded under a thermo-compression condition. During such mixing or stirring, the polysiloxane (polymer) included in the first component and the polysiloxane (polymer) included in the second component may react with each other to be cured. Therefore, the two-component type polymer resin including the first component and the second component and the binder including the two-component type polymer resin may be thermosetting.

As described above, the thermosetting foam type binder composition of an embodiment of the present disclosure may include a foaming agent. The foaming agent may fill the pores of ferrite magnetic particles and powder even at a low binder content by foaming during the manufacture of the magnetic pad, thereby improving the appearance and mechanical properties.

The foaming agent may be included in an amount of 1 to 10 parts by weight, or 3 to 7 parts by weight.

If the amount is less than the range, foaming may not occur properly even when exposed to heat.

If the amount is more than the range, a problem of reducing dimensional accuracy may occur during molding due to overfoaming.

The foaming agent may include at least one selected from the group consisting of azo-based, hydrazide-based, inorganic-based, and microcapsule-based foaming agents.

In one example, the foaming agent may be a capsule-type foaming agent having a particle size of 10 to 30 μm. The thermosetting foam type binder composition according to an embodiment of the present disclosure may include a foaming agent, and may enable volume expansion by foaming when exposed to heat. Through this, mechanical properties may be improved and moldability may be excellent.

The mixing weight ratio of the main polymer resin and the foaming agent may be 80:1 to 10:1. Preferably in an embodiment, the mixing weight ratio may be 45:1 to 15:1. More preferably in an embodiment, the mixing weight ratio may be 35:1 to 15:1.

When the mixing weight ratio is less than 80:1, the foaming rate may be low, which may deteriorate the appearance and mechanical strength of the magnetic pad.

When the mixing weight ratio is more than 10:1, the dimensional accuracy of a molded article may be deteriorated due to overfoaming.

The thermosetting foam type binder composition according to various embodiments of the present disclosure may have a foaming initiation temperature of 70 to 110° C. The foaming initiation temperature of the thermosetting foam type binder composition can be caused by the foaming initiation temperature of the foaming agent, and may be hardly affected by other components included in the binder.

When the foaming initiation temperature is less than the range of 70 to 110° C., the moldability and storability may be deteriorated due to early foaming during a thermo-compression molding process, when manufacturing the magnetic pad according to an embodiment of the present disclosure.

When the foaming initiation temperature is more than the range of 70 to 110° C., the foaming effect may be minimal during the thermo-compression molding process, when manufacturing the magnetic pad according to an embodiment of the present disclosure.

The thermosetting foam type binder composition according to various embodiments of the present disclosure may have a foaming rate of 50 to 400%. In an embodiment of the present disclosure, the foaming rate may refer to a volume increase rate when 10 g of the binder is injected into an aluminum cup and exposed at 175° C. for 10 minutes.

When the foaming rate is less than the range of 50 to 400%, the foaming effect may be reduced and the moldability and appearance may be deteriorated, when manufacturing the magnetic pad according to an embodiment of the present disclosure.

When the foaming rate is more than the range of 50 to 400%, the density may be reduced and the dimensional stability may be deteriorated due to overfoaming, when manufacturing the magnetic pad according to an embodiment of the present disclosure.

The thermosetting foam type binder composition according to various embodiments of the present disclosure may have a viscosity of 3,000 to 100,000 cP.

When the viscosity is less than the range, the mixing stability of the binder, magnetic material pellets, and powder may be deteriorated to cause binder sedimentation, when manufacturing the magnetic pad according to an embodiment of the present disclosure.

When the viscosity is more than the range, the mixing uniformity of the binder, magnetic material pellets, and powder may be deteriorated, when manufacturing the magnetic pad according to an embodiment of the present disclosure.

The thermosetting foam type binder composition according to an embodiment of the present disclosure may further include an additive. The additive may include a (curing) catalyst, a curing retardant, a silane coupling agent, an inorganic filler, a lubricant, and the like. However, the additive is not limited to these, and may use any additive that may be used to improve the properties of the thermosetting foam type binder composition in the art.

In an embodiment of the present disclosure, the (curing) catalyst may include platinum (Pt). In one example, the catalyst may be included in the first component. In an embodiment, the catalyst may be included in an amount of 0.001 to 0.1 parts by weight.

In an embodiment of the present disclosure, the curing retardant may be a compound including aliphatic unsaturated bonds. For example, the compound including the aliphatic unsaturated bonds may include one or two or more substances selected from the group consisting of 1-ethynyl-1-cyclohexanol, 3-methyl-1-penten-3-ol, 2-methyl-3-butyn-2-ol, 3-phenyl-3-butyn-2-ol, 2-phenyl-3-butyn-2-ol, 3,5-dimethyl-1-hexyn-3-ol, 1,5-hexadiyne, 1,6-heptadiyne, 3,5-dimethyl-1-hexyne, 2-ethyl-3-butyne, 2-phenyl-3-butyne, 1,3-divinyltetramethyldisiloxane, 1,3,5,7-tetravinyl-1,3,5,7-tetramethylcyclotetrasiloxane, and 1,3-divinyl-1,3-diphenyldimethyldisiloxane.

In an embodiment of the present disclosure, the curing retardant may be 1-ethynylcyclohexanol (ECH). However, the curing retardant is not limited thereto, and may use any curing retardant that may be used in the art. The curing retardant may serve to improve the preservation stability or adjust the reactivity of a hydrosilylation reaction during the curing process.

In one example, the curing retardant may be included in the second component. The curing retardant may be included in an amount of 0.01 to 1 part by weight.

In an embodiment of the present disclosure, the silane coupling agent may be at least one selected from the group consisting of, for example, vinyltris(β-methoxyethoxy) silane, γ-methacryloxypropyltrimethoxysilane, γ-glycidoxypropyltrimethoxysilane, β-(3,4-epoxycyclohexyl)ethyltrimethoxysilane, γ-glycidoxypropylmethyldiethoxysilane, γ-aminopropyltriethoxysilane, γ-mercaptopropyltrimethoxysilane, γ-chloropropyltrimethoxysilane, vinyltrichlorosilane, and methyltriacetoxysilane. However, the silane coupling agent is not limited thereto, and may use any silane coupling agent that may be used in the art. Preferably in an embodiment, the silane coupling agent may be epoxy-based silane or amino-based silane.

The silane coupling agent may have both a reactive group capable of binding to an organic functional group and a reactive group capable of binding to an inorganic material in the molecule. Therefore, the adhesion between different materials may be improved. The accompanying mechanical strength, water resistance, weather resistance, heat resistance, etc. may be improved. In an embodiment of the present disclosure, the silane coupling agent may improve the interfacial adhesion between the thermosetting foam type binder and a ferrite filler (powder or pellet).

In an embodiment of the present disclosure, the silane coupling agent may be included in the first component or the second component.

The inorganic filler according to an embodiment of the present disclosure may include at least one selected from the group consisting of talc, clay, calcium carbonate, mica, whiskers, silica fume, carbon fiber, barium sulfate, and wollastonite. The inorganic filler may impart excellent filling properties, elongation, heat resistance, cold resistance, and weather resistance. The inorganic filler may serve to effectively repair cracks caused by various factors and improve fire resistance performance by increasing the flash point.

In an embodiment of the present disclosure, the inorganic filler may be silica fume (or fumed silica). However, the inorganic filler is not limited thereto, and may use any inorganic filler that may be used in the art.

In one example, the inorganic filler may be included in the first component and the second component. At this time, the inorganic filler included in the first component may be included in an amount of 5 to 17 parts by weight. The inorganic filler included in the second component may be included in an amount of 5 to 15 parts by weight.

In an embodiment of the present disclosure, the lubricant may include any one selected from the group consisting of, for example, fatty acid-based lubricants such as stearic acid, hydroxystearic acid complex stearic acid, and oleic acid; aliphatic alcohol-based lubricants; aliphatic amide-based lubricants such as stearamide, oxystearic amide, oleyl amide, elsyl amide, ricinol amide, behenamide, methylol amide, methylene bis stearamide, methylene bis stearbehenamide, bisamic acid of higher fatty acids, and complex amides; aliphatic ester-based lubricants such as n-butyl stearate, methyl hydroxystearate, polyhydric alcohol fatty acid esters, saturated fatty acid esters, and ester waxes; fatty acid metal soap-based lubricants, and combinations thereof. The lubricant may be included in the thermosetting foam type binder composition according to an embodiment of the present disclosure to reduce friction between particles, thereby improving density and preventing internal stress.

In an embodiment of the present disclosure, the lubricant may be included in the first component or the second component.

The magnetic pad of an embodiment of the present disclosure may include magnetic material pellets, magnetic material powder, and a thermosetting foam type composition according to various embodiments of the present disclosure.

In one example, the magnetic pad may be manufactured by mixing magnetic material pellets, magnetic material powder, and the thermosetting foam type composition according to various embodiments of the present disclosure to prepare a paste, and then thermo-compressing the paste.

Volume expansion and thermosetting can occur within the magnetic pad through thermo-compressing, so that the impact resistance and moldability of the magnetic pad may be excellent.

The magnetic material pellet may be a MnZn ferrite pellet. In one example, the magnetic material pellet may be a spherical MnZn ferrite pellet having a diameter of 2 mm to 5 mm.

The magnetic pad of an embodiment of the present disclosure may include the magnetic material pellets in an amount of 65 to 95 parts by weight. Preferably in an embodiment, the magnetic material pellets may be included in an amount of 70 to 80 parts by weight. When the magnetic material pellets are included in an amount of less than 65 parts by weight, the magnetic properties of the magnetic pad may be deteriorated. When the magnetic material pellets are included in an amount of more than 95 parts by weight, the moldability of the magnetic pad may be deteriorated. Therefore, the above range may be preferable for an embodiment.

The magnetic material powder may be MnZn ferrite powder. In one example, the magnetic material powder may be MnZn ferrite powder having a diameter of 75 μm to 85 μm.

The magnetic pad of an embodiment of the present disclosure may include the magnetic material powder in an amount of 10 to 25 parts by weight. Preferably in an embodiment, the magnetic material powder may be included in an amount of 15 to 21 parts by weight. When the magnetic material powder is included in an amount of less than 10 parts by weight, the moldability of the magnetic pad may be deteriorated. When the magnetic material powder is included in an amount of more than 25 parts by weight, the magnetic properties of the magnetic pad may be deteriorated. Therefore, the above range may be preferable for an embodiment.

The magnetic pad of an embodiment of the present disclosure may include 1.5 to 7 parts by weight of the thermosetting foam type composition according to various embodiments of the present disclosure described above. Preferably in an embodiment, the thermosetting foam type composition may be included in an amount of 2 to 5 parts by weight. When the thermosetting foam type composition is included in an amount of less than 1.5 parts by weight, the moldability of the magnetic pad may be deteriorated. When the thermosetting foam type composition is included in an amount of more than 7 parts by weight, the magnetic properties of the magnetic pad may be deteriorated. Therefore, the above range may be preferable in an embodiment.

Because the thermosetting foam type composition can be the same as the thermosetting foam type composition according to various embodiments described above, a description thereof will be omitted.

The wireless charging device of an embodiment of the present disclosure may include the magnetic pad according to various embodiments of the present disclosure described above. In one example, the wireless charging device may be a wireless charging device for an electric vehicle.

Hereinafter, the present disclosure will be described in more detail with reference to Examples. However, the following Examples and Experimental Examples are only intended to describe the present disclosure in more detail, and the scopes of the present disclosure is not necessarily limited by the following Examples and Experimental Examples.

### Example 1

### Example 1-1

To manufacture a two-component type thermosetting foam type binder, a first component and a second component were prepared. The first component was prepared by mixing 31.3 parts by weight of vinyldimethylpolysiloxane (viscosity 7,000 cP), 4.9 parts by weight of dimethylpolysiloxane (viscosity 6,000 cP), 12.2 parts by weight of fumed silica, and 0.039 parts by weight of a platinum (Pt 1%) catalyst.

The second component was prepared by mixing 24.3 parts by weight of vinyldimethylpolysiloxane (viscosity 7,000 cP), 10.7 parts by weight of organohydrogenpolysiloxane (viscosity 5,000 cP), 10.3 parts by weight of fumed silica, and 0.029 parts by weight of a curing retardant (ECH, 1-ethynyl-1-cyclohexanol).

After mixing the prepared first and second components, 3.0 parts by weight of a capsule-type foaming agent (foaming initiation temperature of 90° C., particle size of 15 μm) was additionally mixed. The mixture was stirred and degassed to prepare a binder.

### Example 1-2

A magnetic pad including a thermosetting foam type binder was prepared.

First, 76.2 g (diameter of 3 mm) of MnZn ferrite pellets, 19.0 g (diameter of 80 μm) of MnZn ferrite powder, and 4.8 g of the binder according to Example 1-1 were mixed in a horizontal rotary mixer for 1 hour to prepare a paste. The prepared paste was filled into a mold having width (100 mm)×length (100 mm)×height (5 mm), and then compressed at a pressure of 0.35 ton/cm² for 10 minutes using a press preheated to 120° C. to prepare a magnetic pad.

### Example 2

### Example 2-1

A binder was prepared in the same manner as in Example 1-1, except for using vinyldimethylpolysiloxane (viscosity 4,000 cP) and dimethylpolysiloxane (viscosity 3,000 cP) as a first component, and vinyldimethylpolysiloxane (viscosity 4,000 cP) and organohydrogenpolysiloxane (viscosity 2,500 cP) as a second component.

### Example 2-2

A magnetic pad was prepared in the same manner as in Example 1-2, except for using the binder according to Example 2-1.

### Example 3

### Example 3-1

A binder was prepared in the same manner as in Example 1-1, except for using vinyldimethylpolysiloxane (viscosity 30,000 cP) and dimethylpolysiloxane (viscosity 25,000 cP) as the first component, and vinyldimethylpolysiloxane (viscosity 30,000 cP) and organohydrogenpolysiloxane (viscosity 20,000 cP) as the second component.

### Example 3-2

A magnetic pad was prepared in the same manner as in Example 1-2, except for using the binder according to Example 3-1.

### Example 4

### Example 4-1

A binder was prepared in the same manner as in Example 1-1, except for mixing 1.5 parts by weight of a capsule-type foaming agent.

### Example 4-2

A magnetic pad was prepared in the same manner as in Example 1-2, except for using the binder according to Example 4-1.

### Example 5

### Example 5-1

A binder was prepared in the same manner as in Example 1-1, except for mixing 5.0 parts by weight of the capsule-type foaming agent.

### Example 5-2

A magnetic pad was prepared in the same manner as in Example 1-2, except for using the binder according to Example 5-1.

### Example 6

### Example 6-1

A binder was prepared in the same manner as Example 1-1, except for using a capsule-type foaming agent having a foaming initiation temperature of 75° C.

### Example 6-2

A magnetic pad was prepared in the same manner as in Example 1-2, except for using the binder according to Example 6-1.

### Example 7

### Example 7-1

A binder was prepared in the same manner as Example 1-1, except for using a capsule-type foaming agent having a foaming initiation temperature of 105° C.

### Example 7-2

A magnetic pad was prepared in the same manner as in Example 1-2, except for using the binder according to Example 7-1.

### Comparative Example 1

### Comparative Example 1-1

A binder was prepared in the same manner as in Example 1-1, except for using vinyldimethylpolysiloxane (viscosity 1,000 cP) and dimethylpolysiloxane (viscosity 800 cP) as a first component, and vinyldimethylpolysiloxane (viscosity 1,000 cP) and organohydrogenpolysiloxane (viscosity 800 cP) as a second component.

### Comparative Example 1-2

A magnetic pad was prepared in the same manner as in Example 1-2, except for using the binder according to Comparative Example 1-1.

### Comparative Example 2

### Comparative Example 2-1

A binder was prepared in the same manner as in Example 1-1, except for using vinyldimethylpolysiloxane (viscosity 90,000 cP) and dimethylpolysiloxane (viscosity 80,000 cP) as a first component, and vinyldimethylpolysiloxane (viscosity 90,000 cP) and organohydrogenpolysiloxane (viscosity 85,000 cP) as a second component.

### Comparative Example 2-2

A magnetic pad was prepared in the same manner as in Example 1-2, except for using the binder according to Comparative Example 2-1.

### Comparative Example 3

### Comparative Example 3-1

A binder was prepared in the same manner as in Example 1-1, except for not mixing a foaming agent.

### Comparative Example 3-2

A magnetic pad was prepared in the same manner as in Example 1-2, except for using the binder according to Comparative Example 3-1.

### Comparative Example 4

### Comparative Example 4-1

A binder was prepared in the same manner as in Example 1-1, except for mixing 0.5 parts by weight of a capsule-type foaming agent.

### Comparative Example 4-2

A magnetic pad was prepared in the same manner as in Example 1-2, except for using the binder according to Comparative Example 4-1.

### Comparative Example 5

### Comparative Example 5-1

A binder was prepared in the same manner as in Example 1-1, except for mixing 10.0 parts by weight of a capsule-type foaming agent.

### Comparative Example 5-2

A magnetic pad was prepared in the same manner as in Example 1-2, except for using the binder according to Comparative Example 5-1.

### Comparative Example 6

### Comparative Example 6-1

A binder was prepared in the same manner as Example 1-1, except for using a capsule-type foaming agent having a foaming initiation temperature of 60° C.

### Comparative Example 6-2

A magnetic pad was prepared in the same manner as in Example 1-2, except for using the binder according to Comparative Example 6-1.

### Comparative Example 7

### Comparative Example 7-1

A binder was prepared in the same manner as Example 1-1, except for using a capsule-type foaming agent having a foaming initiation temperature of 125° C.

### Comparative Example 7-2

A magnetic pad was prepared in the same manner as in Example 1-2, except for using the binder according to Comparative Example 7-1.

### Comparative Example 8

### Comparative Example 8-1

A conventional product QS119F two-component type silicone foam having a foaming initiation temperature of room temperature was prepared as a binder.

### Comparative Example 8-2

A magnetic pad was prepared in the same manner as in Example 1-2, except for using the binder according to Comparative Example 8-1.

The binder compositions of Examples and Comparative Examples above were summarized in Table 1 below.

TABLE 1

| | | | | | | | | | Foaming agent |
|---|---|---|---|---|---|---|---|---|---|
| | First component | | | | Second component | | | | (foaming |
| | Vinyldimethyl- | Dimethylpoly- | | | Vinyldimethyl- | Organohydroxy- | | | initiation |
| | polysiloxane | siloxane | | | polysiloxane | gempolysiloxane | | Curing | temperature, |
| | (viscosity) | (viscosity) | Extender | Catalyst | (viscosity) | (viscosity) | Extender | retardant | particle size) |
| Ex. 1-1 | 31.3 | 4.9 | 12.2 | 0.039 | 24.3 | 10.7 | 10.3 | 0.029 | 3.0 (90° C., |
| | (7,000 cP) | (6,000 cP) | | | (7,000 cP) | (5,000 cP) | | | 15 μm) |
| Ex. 2-1 | 31.3 | 4.9 | 12.2 | 0.039 | 24.3 | 10.7 | 10.3 | 0.029 | 3.0 (90° C., |
| | (4,000 cP) | (3,000 cP) | | | (4,000 cP) | (2,500 cP) | | | 15 μm) |
| Ex. 3-1 | 31.3 | 4.9 | 12.2 | 0.039 | 24.3 | 10.7 | 10.3 | 0.029 | 3.0 (90° C., |
| | (30,000 cP) | (25,000 cP) | | | (30,000 cP) | (20,000 cP) | | | 15 μm) |
| Ex. 4-1 | 31.3 | 4.9 | 12.2 | 0.039 | 24.3 | 10.7 | 10.3 | 0.029 | 1.5 (90° C., |
| | (7,000 cP) | (6,000 cP) | | | (7,000 cP) | (5,000 cP) | | | 15 μm) |
| Ex. 5-1 | 31.3 | 4.9 | 12.2 | 0.039 | 24.3 | 10.7 | 10.3 | 0.029 | 5.0 (90° C., |
| | (7,000 cP) | (6,000 cP) | | | (7,000 cP) | (5,000 cP) | | | 15 μm) |
| Ex. 6-1 | 31.3 | 4.9 | 12.2 | 0.039 | 24.3 | 10.7 | 10.3 | 0.029 | 3.0 (75° C., |
| | (7,000 cP) | (6,000 cP) | | | (7,000 cP) | (5,000 cP) | | | 15 μm) |
| Ex. 7-1 | 31.3 | 4.9 | 12.2 | 0.039 | 24.3 | 10.7 | 10.3 | 0.029 | 3.0 (105° C., |
| | (7,000 cP) | (6,000 cP) | | | (7,000 cP) | (5,000 cP) | | | 15 μm) |
| Com. | 31.3 | 4.9 | 12.2 | 0.039 | 24.3 | 10.7 | 10.3 | 0.029 | 3.0 (90° C., |
| Ex. 1-1 | (1,000 cP) | (800 cP) | | | (1,000 cP) | (800 cP) | | | 15 μm) |
| Com. | 31.3 | 4.9 | 12.2 | 0.039 | 24.3 | 10.7 | 10.3 | 0.029 | 3.0 (90° C., |
| Ex. 2-1 | (90,000 cP) | (80,000 cP) | | | (90,000 cP) | (85,000 cP) | | | 15 μm) |
| Com. | 31.3 | 4.9 | 12.2 | 0.039 | 24.3 | 10.7 | 10.3 | 0.029 | — |
| Ex. 3-1 | (7,000 cP) | (6,000 cP) | | | (7,000 cP) | (5,000 cP) | | | |
| Com. | 31.3 | 4.9 | 12.2 | 0.039 | 24.3 | 10.7 | 10.3 | 0.029 | 0.5 (90° C., |
| Ex. 4-1 | (7,000 cP) | (6,000 cP) | | | (7,000 cP) | (5,000 cP) | | | 15 μm) |
| Com. | 31.3 | 4.9 | 12.2 | 0.039 | 24.3 | 10.7 | 10.3 | 0.029 | 10.0 (90° C., |
| Ex. 5-1 | (7,000 cP) | (6,000 cP) | | | (7,000 cP) | (5,000 cP) | | | 15 μm) |
| Com. | 31.3 | 4.9 | 12.2 | 0.039 | 24.3 | 10.7 | 10.3 | 0.029 | 3.0 (60° C., |
| Ex. 6-1 | (7,000 cP) | (6,000 cP) | | | (7,000 cP) | (5,000 cP) | | | 15 μm) |
| Com. | 31.3 | 4.9 | 12.2 | 0.039 | 24.3 | 10.7 | 10.3 | 0.029 | 3.0 (125° C., |
| Ex. 7-1 | (7,000 cP) | (6,000 cP) | | | (7,000 cP) | (5,000 cP) | | | 15 μm) |
| Com. | QS119F 2-component type silicon foam | | | | | | | | |
| Ex. 8-1 | | | | | | | | | |

### Experimental Example 1

### Measurement of Properties of Binders

In Experimental Example 1, the properties (viscosity, foaming rate, foaming initiation temperature, and working time) of the binders according to Examples and Comparative Examples were measured and summarized in Table 2 below. The viscosity was measured using a Brookfield viscometer, the foaming rate was measured by exposing 10 g of the binder to an aluminum cup at 175° C. for 10 minutes to measure a volume increase rate, and the working time referred to a time point at which workability became poor due to an increase in viscosity caused by a curing reaction at room temperature.

TABLE 2

| | Properties of binder | | | |
|---|---|---|---|---|
| | | Foaming | Foaming | |
| | Viscosity (cP) | rate (%) | initiation temperature (° C.) | Working time (25° C.) |
| Example 1-1 | 10,000 | 150 | 90 | After 3 days |
| Example 2-1 | 5,000 | 150 | 90 | After 3 days |
| Example 3-1 | 40,000 | 150 | 90 | After 3 days |
| Example 4-1 | 10,000 | 80 | 90 | After 3 days |
| Example 5-1 | 10,000 | 250 | 90 | After 3 days |
| Example 6-1 | 10,000 | 150 | 75 | After 3 days |
| Example 7-1 | 10,000 | 150 | 105 | After 3 days |
| Comparative | 1,500 | 150 | 90 | After 3 days |
| Example 1-1 | | | | |
| Comparative | 150,000 | 80 | 90 | After 3 days |
| Example 2-1 | | | | |
| Comparative | 10,000 | 0 | N/A | After 3 days |
| Example 3-1 | | | | |
| Comparative | 10,000 | 30 | 90 | After 3 days |
| Example 4-1 | | | | |
| Comparative | 10,000 | 500 | 90 | After 3 days |
| Example 5-1 | | | | |
| Comparative | 10,000 | 420 | 60 | After 3 days |
| Example 6-1 | | | | |
| Comparative | 10,000 | 20 | 125 | After 3 days |
| Example 7-1 | | | | |
| Comparative | 8,000 | 350 | 25 | Within 10 |
| Example 8-1 | | | | minutes |

Referring to Table 2, it may be seen that the binders of Examples all have a foaming initiation temperature of 70 to 110° C., a foaming rate of 50 to 400%, and a viscosity of 3,000 to 100,000 cP. On the other hand, it may be seen that in the case of Comparative Examples 1 and 2, the viscosity is out of the range, in the case of Comparative Examples 3, 6 to 8, the foaming initiation temperature is out of the range, and in the case of Comparative Examples 3 to 7, the foaming rate is out of the range. Accordingly, it may be inferred that the binders of Examples are superior to the binders of Comparative Examples in terms of moldability and magnetic properties, when manufacturing the magnetic pads.

### Experimental Example 2

### Evaluation of Mixability

In Experimental Example 2, the following experiment was performed to measure and evaluate the mixability of the magnetic pads according to Examples and Comparative Examples.

In manufacturing the magnetic pads according to Examples and Comparative Examples, the mixing state of a paste prepared as an intermediate was visually observed. When observing, as the MnZn ferrite pellets, powder, and binder were mixed uniformly, the mixability was evaluated as 5, and as the binder was not evenly applied, there was severe agglomeration between the MnZn ferrite pellets and powder, or the binder stability was poor, the mixability was evaluated as 1. The results were shown in Table 3 below.

TABLE 3

| | Properties of magnetic pad |
|---|---|
| | Paste mixability |
| Example 1-2 | 4 |
| Example 2-2 | 5 |
| Example 3-2 | 4 |
| Example 4-2 | 4 |
| Example 5-2 | 4 |
| Example 6-2 | 4 |
| Example 7-2 | 4 |
| Comparative Example 1-2 | 2 |
| Comparative Example 2-2 | 1 |
| Comparative Example 3-2 | 4 |
| Comparative Example 4-2 | 4 |
| Comparative Example 5-2 | 4 |
| Comparative Example 6-2 | 4 |
| Comparative Example 7-2 | 4 |
| Comparative Example 8-2 | 1 |

Referring to Table 3, in the case of Examples, the MnZn ferrite pellets, powder, and binder were uniformly observed, and thus evaluation values were 4 or higher, whereas in the case of Comparative Examples, the evaluation values were 1 to 4, which had lower uniformity than in the case of Examples. Through this, it may be inferred that the magnetic pads of Examples are superior in terms of mechanical properties.

### Experimental Example 3

### Measurement of Mechanical Strength and Impact Resistance

In Experimental Example 3, the mechanical strength such as impact resistance was evaluated for the magnetic pads according to Examples and Comparative Examples. The magnetic pads of Examples and Comparative Examples were prepared, and then dropped three times from a height of 1.5 m to observe whether the magnetic pads were broken, or the pellets were detached. When the magnetic pads were broken or cracked, or when some of the pellets at the corners were detached, the pad appearance was evaluated as “poor”, and when there was no deformation of the appearance after the dropping, the pad appearance was evaluated as “good”. The results are shown in Table 4 below.

TABLE 4

| | Properties of magnetic pad | |
|---|---|---|
| | | Impact resistance |
| | Pad appearance | (1.5 m dropping three times) |
| Example 1-2 | Good | PASS |
| Example 2-2 | Good | PASS |
| Example 3-2 | Good | PASS |
| Example 4-2 | Good | PASS |
| Example 5-2 | Good | PASS |
| Example 6-2 | Good | PASS |
| Example 7-2 | Good | PASS |
| Comparative Example 1-2 | Poor (binder ununiformity) | NG (pellet detachment) |
| Comparative Example 2-2 | Poor (binder ununiformity) | NG (pellet detachment) |
| Comparative Example 3-2 | Poor (dimensional ununiformity) | NG (pellet detachment) |
| Comparative Example 4-2 | Poor (dimensional | NG (pellet detachment) |
| | ununiformity) | |
| Comparative Example 5-2 | Poor (dimensional | PASS |
| | ununiformity) | |
| Comparative Example 6-2 | Poor (dimensional | PASS |
| | ununiformity) | |
| Comparative Example 7-2 | Poor (dimensional | NG (pellet detachment) |
| | ununiformity) | |
| Comparative Example 8-2 | Poor molding | Poor molding |

Referring to Table 4, after the drop experiment, all the magnetic pads of Comparative Examples were evaluated as “poor” in the pad appearance due to reasons such as the pads being broken, and pellet detachment was observed in Comparative Examples 1-2 to 4-2 and 7-2 to 8-2. On the other hand, it may be seen that in all of the magnetic pads of Examples, pellet detachment was not observed, the pads were broken, and the cracks did not occur, and thus all of the pad appearances were evaluated as “good”. Through this, it may be seen that the magnetic pads of Examples have excellent impact resistance and better mechanical properties than the magnetic pads of Comparative Examples.

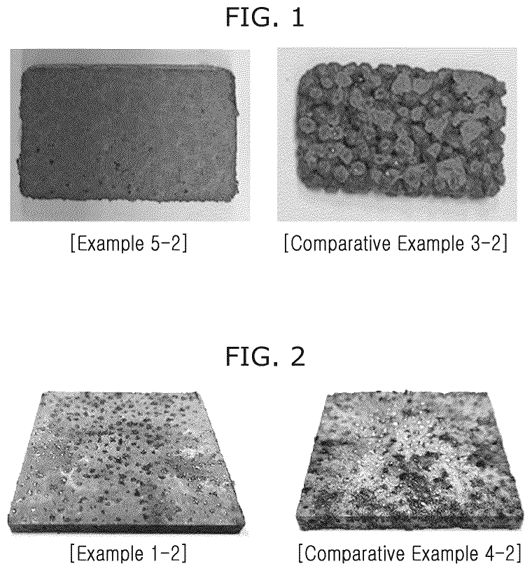

Meanwhile, the molding states and detachment of the magnetic pads according to Examples and Comparative Examples were visually observed. The appearances of the magnetic pad of Example 5-2 and the magnetic pad of Comparative Example 3-2 were visually observed and shown in FIG. 1, and the appearances of the magnetic pad of Example 1-2 and the magnetic pad of Comparative Example 4-2 were visually observed and shown in FIG. 2.

Referring to FIG. 1, it may be confirmed that the magnetic pad of Comparative Example 3-2 has an uneven surface. The reason may be that the magnetic pad of Comparative Example 3-2 does not include a foaming agent, so that the dimensional stability is low and the moldability is also poor.

Referring to FIG. 2, it may be observed that the magnetic pad of Comparative Example 4-2 has a poor pad appearance and pellets are detached. The reason may be that Comparative Example 4-2 includes a small amount of foaming agent and thus has insufficient foaming properties.

### Experimental Example 4

### Measurement of Density

In Experimental Example 4, the densities of the magnetic pads according to Examples and Comparative Examples were measured. The densities were calculated using the following Equation 1.

$$Density ( \% ) = weight of magnetic pad / volume of magnetic pad \times 100 \qquad Equation 1$$

The results thereof were shown in Table 5 below.

TABLE 5

| | Properties of magnetic pad |
|---|---|
| | Density (g/cm³) |
| Example 1-2 | 3.85 |
| Example 2-2 | 3.80 |
| Example 3-2 | 3.89 |
| Example 4-2 | 3.78 |
| Example 5-2 | 3.90 |
| Example 6-2 | 3.88 |
| Example 7-2 | 3.85 |
| Comparative Example 1-2 | 3.82 |
| Comparative Example 2-2 | 3.55 |
| Comparative Example 3-2 | 3.75 |
| Comparative Example 4-2 | 3.77 |
| Comparative Example 5-2 | 3.55 |
| Comparative Example 6-2 | 3.65 |
| Comparative Example 7-2 | 3.75 |
| Comparative Example 8-2 | 3.45 |

Referring to Table 5, it may be seen that the densities of the magnetic pads according to Comparative Examples are 3.45 to 3.82, while the densities of the magnetic pads according to Examples are 3.78 to 3.90. Through this, it may be inferred that the magnetic pads of Examples have relatively high densities and thus superior in terms of dimensional stability.

### Experimental Example 5

### Measurement of Dimensional Accuracy

In Experimental Example 5, the dimensional accuracy of the magnetic pads according to Examples and Comparative Examples was measured. The dimensional accuracy was evaluated by setting (actual sample volume/mold volume×100(%)). The actual volume of the sample was measured using a hydrometer for the actual volume of the manufactured magnetic pad. The results were shown in Table 6 below.

TABLE 6

| | Properties of magnetic pad |
|---|---|
| | Dimensional accuracy (%) |
| Example 1-2 | 98.5% |
| Example 2-2 | 98.2% |
| Example 3-2 | 98.3% |
| Example 4-2 | 98.1% |
| Example 5-2 | 99.3% |
| Example 6-2 | 99.2% |
| Example 7-2 | 98.1% |
| Comparative Example 1-2 | 96.5% |
| Comparative Example 2-2 | 91.5% |
| Comparative Example 3-2 | 92.1% |
| Comparative Example 4-2 | 94.2% |
| Comparative Example 5-2 | 103.0% |
| Comparative Example 6-2 | 102.1% |
| Comparative Example 7-2 | 93.1% |
| Comparative Example 8-2 | Poor molding |

Referring to Table 6, it may be seen that the magnetic pads of Examples all had the dimensional accuracy of 98 to 100%. On the other hand, the magnetic pads of Comparative Examples often had the dimensional accuracy of 91 to 95%, and in particular, it was confirmed that the magnetic pad of Comparative Example 8-2 had poor molding itself. Through this, it was confirmed once again that the magnetic pads of Examples had better moldability.

### Experimental Example 6

### Measurement of Magnetic Properties

In Experimental Example 6, the permeability of the magnetic pads according to Examples and Comparative Examples was measured. The magnetic pads of Examples and Comparative Examples were processed into a Toroid shape with outer diameter of 39 mm×inner diameter of 17 mm×height of 5 mm, and then 10 turns of @0.5 copper wire were wound to measure the inductance using an LCR meter, and the permeability was converted based on the following Equation 2.

$$μ ( Permeability ) = \frac{( L \times l )}{( 0.4 \times π \times {N}^{2} \times A \times 0.01 )} \qquad Equation 2$$

(L: inductance (uH), 1: Mean free path (cm), N: number of turns, A: cross-sectional area (cm²))

The results thereof are shown in Table 7 below.

TABLE 7

| | Properties of magnetic pad |
|---|---|
| | Permeability |
| Example 1-2 | 58.3 |
| Example 2-2 | 54.5 |
| Example 3-2 | 56.9 |
| Example 4-2 | 53.9 |
| Example 5-2 | 56.6 |
| Example 6-2 | 54.3 |
| Example 7-2 | 56.8 |
| Comparative Example 1-2 | 51.9 |
| Comparative Example 2-2 | 37.7 |
| Comparative Example 3-2 | 50.5 |
| Comparative Example 4-2 | 50.9 |
| Comparative Example 5-2 | 41.1 |
| Comparative Example 6-2 | 44.1 |
| Comparative Example 7-2 | 50.8 |
| Comparative Example 8-2 | 35.6 |

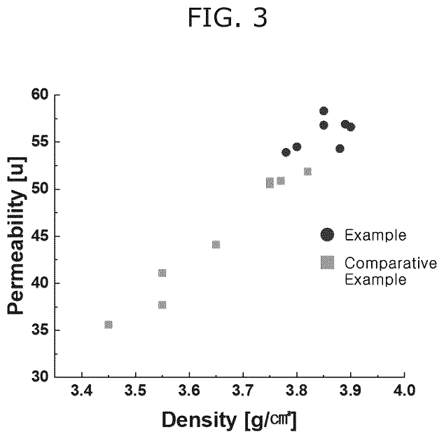

Referring to Table 7, it may be seen that the magnetic pads of Examples have permeability values of 53.9 to 58.3, while the magnetic pads of Comparative Examples have permeability values of 35.6 to 51.9. Through this, it may be seen that the magnetic pads of Examples are superior to the magnetic pads of Comparative Examples in terms of magnetic properties. Meanwhile, a plot is made to see a relationship between the densities of Examples and Comparative Examples measured in Experimental Example 4 and the permeability measured in Experimental Example 6, as shown in FIG. 3. As may be seen from FIG. 3, it may be seen that Examples have higher values than Comparative Examples in terms of both density and permeability.

Hereinabove, the present disclosure has been described with reference to preferred examples thereof. It can be understood to those skilled in the art that the present disclosure may be implemented as modified forms without departing from scopes of the present disclosure. Therefore, the disclosed examples should be considered in an illustrative viewpoint rather than a necessarily restrictive viewpoint. The scopes of the present disclosure can be described by the appended claims, and differences within the scopes of equivalents thereof can be construed as being included in the present disclosure.

What is claimed is:

1. A thermosetting foam type binder composition comprising:
a main polymer resin; and
a foaming agent having a foaming initiation temperature of 70 to 110° C., a foaming rate of 50 to 400%, and a viscosity of 3,000 to 100,000 cP.

2. The composition of claim 1, wherein the main polymer resin and the foaming agent are mixed in a weight ratio for the main polymer resin to the foaming agent in a mixture ratio range of 80:1 to 10:1.

3. The composition of claim 1, wherein the main polymer resin is a two-component type polymer resin comprising:
a first component comprising vinyldimethylpolysiloxane; and
a second component comprising organohydrogenpolysiloxane.

4. The composition of claim 3, wherein the first component further comprises dimethylpolysiloxane, and wherein the second component further comprises vinyldimethylpolysiloxane.

5. The composition of claim 4, wherein the first component comprises:
25 to 35 parts by weight of vinyldimethylpolysiloxane, and
1 to 10 parts by weight of dimethylpolysiloxane; and
wherein the second component comprises:
20 to 30 parts by weight of vinyldimethylpolysiloxane, and
5 to 15 parts by weight of organohydrogenpolysiloxane.

6. The composition of claim 1, wherein the foaming agent comprises at least one selected from the group consisting of azo-based, hydrazide-based, inorganic-based, and microcapsule-based foaming agents.

7. The composition of claim 1, wherein the foaming agent is a capsule-type foaming agent having a particle size of 10 to 30 μm.

8. A magnetic pad comprising:
1.5 to 7 parts by weight of a thermosetting foam type binder composition comprising:
a main polymer resin, and
a foaming agent having a foaming initiation temperature of 70 to 110° C., a foaming rate of 50 to 400%, and a viscosity of 3,000 to 100,000 cP.

9. The magnetic pad of claim 8, wherein the main polymer resin is a two-component type polymer resin comprising:
a first component comprising vinyldimethylpolysiloxane, wherein the first component further comprises dimethylpolysiloxane, and wherein the first component comprises:
25 to 35 parts by weight of vinyldimethylpolysiloxane, and
1 to 10 parts by weight of dimethylpolysiloxane; and
a second component comprising organohydrogenpolysiloxane, wherein the second component further comprises vinyldimethylpolysiloxane, and wherein the second component comprises:
20 to 30 parts by weight of vinyldimethylpolysiloxane, and
5 to 15 parts by weight of organohydrogenpolysiloxane.

10. The magnetic pad of claim 9, wherein the foaming agent comprises at least one selected from the group consisting of azo-based, hydrazide-based, inorganic-based, and microcapsule-based foaming agents,
wherein the foaming agent is a capsule-type foaming agent having a particle size of 10 to 30 μm,
wherein the main polymer resin and the foaming agent are mixed in a weight ratio for the main polymer resin to the foaming agent in a mixture ratio range of 80:1 to 10:1.

11. A wireless charging device comprising the magnetic pad according to claim 8.

12. The wireless charging device of claim 11, wherein the main polymer resin is a two-component type polymer resin comprising:
a first component comprising vinyldimethylpolysiloxane, wherein the first component further comprises dimethylpolysiloxane, and wherein the first component comprises:
25 to 35 parts by weight of vinyldimethylpolysiloxane, and
1 to 10 parts by weight of dimethylpolysiloxane; and
a second component comprising organohydrogenpolysiloxane, wherein the second component further comprises vinyldimethylpolysiloxane, and wherein the second component comprises:
20 to 30 parts by weight of vinyldimethylpolysiloxane, and
5 to 15 parts by weight of organohydrogenpolysiloxane.

13. The wireless charging device of claim 12, wherein the foaming agent comprises at least one selected from the group consisting of azo-based, hydrazide-based, inorganic-based, and microcapsule-based foaming agents,
wherein the foaming agent is a capsule-type foaming agent having a particle size of 10 to 30 μm, and
wherein the main polymer resin and the foaming agent are mixed in a weight ratio of 80:1 to 10:1.
